(19) United States
(12) Patent Application Publication
(10) Pub. No.: US 2024/0392095 A1
(43) Pub. Date: Nov. 28, 2024

(54) METHOD FOR RECOVERING CYCLIC OLEFIN RESIN

(71) Applicant: GUNZE LIMITED, Kyoto (JP)

(72) Inventors: Tsukasa NAKAO, Shiga (JP); Tatsuya KIBAYASHI, Shiga (JP); Asuka KOIKE, Shiga (JP)

(73) Assignee: GUNZE LIMITED, Kyoto (JP)

(21) Appl. No.: 18/697,063

(22) PCT Filed: Sep. 28, 2022
(86) PCT No.: PCT/JP2022/036319

§ 371 Date: Mar. 29, 2024

(30) Foreign Application Priority Data
Sep. 30, 2021 (JP) 2021-161776

(51) Int. Cl. C08J 11/08; B29B 9/06; B29B 9/12; C08J 5/18

(52) U.S. Cl. CPC C08J 11/08; B29B 9/06; B29B 9/12; C08J 5/18

(57) ABSTRACT

A method for recovering a cyclic olefin resin includes: a composite material containing at least a cyclic olefin resin, and a different resin that is different from the cyclic olefin resin is dissolved in a solvent capable of dissolving the cyclic olefin resin to produce a solution, and a different resin component, which contains the different resin, is precipitated out; the solution is filtered and a filtrate is obtained by removing the different resin component; and a composition containing the cyclic olefin resin is obtained from the filtrate.

### TECHNICAL FIELD

The present invention relates to a method for recovering a cyclic olefin resin.

### BACKGROUND ART

In recent years, there has been proposed a method for recovering a cyclic olefin resin from a molded body of the cyclic olefin resin as in Patent Document 1 in response to a request for recycling of resin materials. Specifically, Patent Document 1 discloses a reuse method in which a cyclic olefin resin molded body is melted and kneaded together with an antioxidant having a melting point of 100° C. or higher, and the obtained resin composition is re-molded.

### PRIOR ART DOCUMENT

### Patent Document

Patent Document 1: Japanese Patent Laid-open Publication No. 2008-222826

### SUMMARY OF THE INVENTION

### Problems to be Solved by the Invention

However, the above method always requires a melting step before formation of a recycled product, and requires equipment related to melting.

The present invention has been made to solve the above problems, and an object of the present invention is to provide a method capable of recovering a cyclic olefin resin from a composite material in which the cyclic olefin resin and another different resin have been mixed, without melting as a prerequisite for separation.

### Means for Solving the Problem

Item 1. A method for recovering a cyclic olefin resin including:

a first step of dissolving a film containing at least the cyclic olefin resin and a different resin different from the cyclic olefin resin in a solvent capable of dissolving the cyclic olefin resin, to form a solution, and precipitating a different resin component containing the different resin;

a second step of filtering the solution and removing the different resin component to obtain a filtrate; and

a third step of obtaining a composition containing the cyclic olefin resin from the filtrate.

Item 2. The method for recovering a cyclic olefin resin according to item 1, in which the film is cut into a predetermined size and then dissolved in the solvent in the first step.

Item 3. The method for recovering a cyclic olefin resin according to item 1 or

2, further including a fourth step of melting and pelletizing the composition to form a recycled film.

Item 4. The method for recovering a cyclic olefin resin according to any one of items 1 to 3, in which the solvent contains at least one of an aromatic solvent, a cyclic terpene solvent, a cyclic ether solvent, or a cycloaliphatic solvent.

Item 5. The method for recovering a cyclic olefin resin according to any one of items 1 to 4, in which the different resin is at least one of a propylene resin, an ethylene resin, a polyester resin, or a polyamide resin.

Item 6. The method for recovering a cyclic olefin resin according to any one of items 1 to 5, in which in the first step, the solution is heated to a temperature of 25° C. or higher.

Item 7. The method for recovering a cyclic olefin resin according to any one of items 1 to 6, in which a composition containing the cyclic olefin resin is obtained in the third step by any one of methods:

a first method of evaporating the solvent from the filtrate;

a second method of diluting the filtrate to precipitate the composition containing the cyclic olefin resin; or

a third method of cooling the filtrate to precipitate the composition containing the cyclic olefin resin.

Item 8. The method for recovering a cyclic olefin resin according to any one of items 1 to 7, in which the composite material is formed of a film, and the film includes at least a first layer containing the cyclic olefin resin and a second layer containing the different resin.

Item 9. The method for recovering a cyclic olefin resin according to item 8, in which at least one of the first layer or the second layer contains at least one of a petroleum resin or an additive.

Item 10. A method for producing a heat-shrinkable film, including the steps of recovering the cyclic olefin resin by the method according to item 1 or 2 and producing the heat-shrinkable film using the cyclic olefin resin recovered.

### Advantages of the Invention

According to the present invention, it is possible to recover a cyclic olefin resin from a composite material in which the cyclic olefin resin and another different resin have been mixed, without melting as a prerequisite for separation.

### BRIEF DESCRIPTION OF THE DRAWINGS

FIG. 1 shows a cross-sectional view showing an example of a target film.

FIG. 2 shows a flowchart of a method for recovering a cyclic olefin resin according to an example of the present invention.

### EMBODIMENT OF THE INVENTION

Hereinafter, an embodiment of a method for recovering a cyclic olefin resin according to the present invention will be described. In the present embodiment, a method for recovering a cyclic olefin resin from a film containing the cyclic olefin resin will be described. First, a target film will be described, and then a separation method will be described.

### <1. Example of Film Containing Cyclic Olefin Resin>

Examples of the target film in the present embodiment include various films, and examples thereof include a film containing a cyclic olefin resin and a different resin that is different from the cyclic olefin resin. As such a film, for example, a film obtained by removing ink from a film collected in a city can be used. The cyclic olefin resin can be separated and recovered from such a film by the technology according to the present invention.

### <1-1. Cyclic Olefin Resin>

Examples of the cyclic olefin resin include (a) a copolymer of ethylene or propylene and a cyclic olefin (for example, norbornene, a derivative thereof, tetracyclododecene, or a derivative thereof), (b) a ring-opened polymer of the cyclic olefin or a copolymer of the cyclic olefin and an α-olefin, (c) a hydrogenated product of the polymer of (b), and (d) graft-modified products of (a) to (c) with an unsaturated carboxylic acid, a derivative thereof, or the like.

The cyclic olefin is not particularly limited, and specific examples thereof include norbornene, 6-methylnorbornene, 6-ethylnorbornene, 5-propylnorbornene, 6-n-butylnorbornene, 1-methylnorbornene, 7-methylnorbornene, 5,6-dimethylnorbornene, 5-phenylnorbornene, and 5-benzylnorbornene.

Examples of the tetracyclododecene and the derivative thereof include 8-methyltetracyclo-3-dodecene, 8-ethyltetracyclo-3-dodecene, and 5,10-dimethyltetracyclo-3-dodecene.

### <1-2. Different Resin>

As an example of the different resin to be separated from the cyclic olefin resin, there may be mentioned at least one of a propylene resin, an ethylene resin, a polyester resin, or a polyamide resin.

Examples of the propylene resin include binary or ternary random copolymers containing propylene as a main component and ethylene, butene, or α-olefin as a copolymerization component. Specifically, the α-olefin is preferably composed of ethylene, 1-butene, 1-hexene, 1-octene or the like, and may contain two or more kinds of α-olefins. The propylene resin may be a mixture of different propylene-α-olefin random copolymers.

Examples of the ethylene resin include a branched low-density polyethylene resin, a linear low-density polyethylene resin, an ethylene-vinyl acetate copolymer, an ionomer resin, and mixtures thereof. In addition, examples thereof include copolymers of ethylene and α-olefin. Examples of the α-olefin include 1-butene, 1-pentene, 1-hexene, 4-methyl-1-pentene, and 1-octene.

The copolymer may be a random copolymer or a block copolymer.

Examples of the polyester resin include those obtained by condensation polymerization of a dicarboxylic acid and a diol.

The dicarboxylic acid is not particularly limited, and examples thereof include o-phthalic acid, terephthalic acid, isophthalic acid, succinic acid, adipic acid, sebacic acid, azelaic acid, octylsuccinic acid, cyclohexanedicarboxylic acid, naphthalenedicarboxylic acid, fumaric acid, maleic acid, itaconic acid, decamethylene carboxylic acid, and anhydrides and lower alkyl esters thereof.

The diol is not particularly limited, and examples thereof include aliphatic diols such as ethylene glycol, 1,3-propanediol, 1,4-butanediol, diethylene glycol, 1,5-pentanediol, 1,6-hexanediol, dipropylene glycol, triethylene glycol, tetraethylene glycol, 1,2-propanediol, 1,3-butanediol, 2,3-butanediol, neopentyl glycol (2,2-dimethylpropane-1,3-diol), 1,2-hexanediol, 2,5-hexanediol, 2-methyl-2,4-pentanediol, 3-methyl-1,3-pentanediol, and 2-ethyl-1,3-hexanediol; and alicyclic diols such as 2,2-bis(4-hydroxycyclohexyl) propane, alkylene oxide adducts of 2,2-bis(4-hydroxycyclohexyl) propane, 1,4-cyclohexanediol, and 1,4-cyclohexanedimethanol.

Examples of the polyamide resin include aliphatic polyamides and aromatic polyamides. Examples of the aliphatic polyamide include aliphatic nylons and copolymers thereof, and specific examples thereof include polycapramide (nylon-6), poly-ω-aminoheptanoic acid (nylon-7), poly-ω-aminononanoic acid (nylon-9), polyundecanamide (nylon-11), polylauryllactam (nylon-12), polyethylene diamine adipamide (nylon-2,6), polytetramethylene adipamide (nylon-4,6), polyhexamethylene adipamide (nylon-6,6), polyhexamethylene sebacamide (nylon-6,10), polyhexamethylene dodecamide (nylon-6,12), polyoctamethylene adipamide (nylon-8,6), and polydecamethylene adipamide (nylon-10,8).

<1-3. Resin and Additive to be Separated Together with Cyclic Olefin Resin>

The cyclic olefin resin to be recovered may be in a form mixed with, for example, a resin (hereinafter, sometimes referred to as a mixed resin) or an additive as long as the resin or additive does not affect transparency. Examples of such a resin include a petroleum resin, a terpene resin, a rosin resin, and a coumarone-indene resin. Examples of the petroleum resin include an alicyclic petroleum resin from cyclopentadiene or a dimer thereof, and an aromatic petroleum resin from a C9 component. Examples of the additive include a heat stabilizer, an antioxidant, an ultraviolet absorber, a light stabilizer, a lubricant, an antistatic agent, a flame retardant, an antibacterial agent, and a fluorescent brightener, and particularly include an additive derived from an organic compound.

Such resins and additives are dissolved together with the cyclic olefin resin in the solvent described later, and are separated and recovered as a mixture with the cyclic olefin resin. However, since the solubilities of the resin and the additive may vary depending on the type of solvent selected in the present technology, the resin and the additive are not necessarily separated in a form mixed with the cyclic olefin resin. Thus, some additives may be separated and recovered as a mixture with different resins. Examples of the additive to be separated in a form mixed with the different resin include additives that do not dissolve in the solvent described later at room temperature, and particularly include inorganic additives and additives derived from crosslinked resins.

### <1-4. Other Examples of Film>

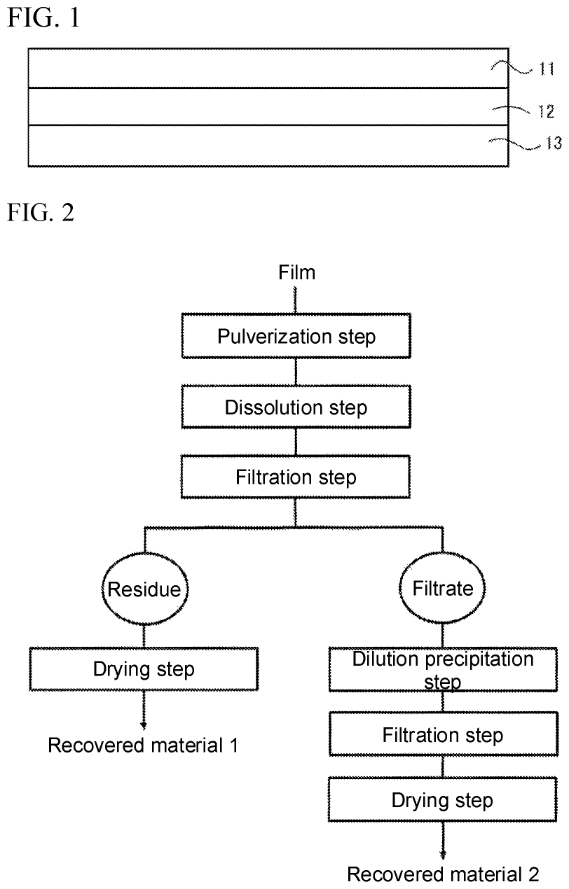

The film may be a single layer film in which a cyclic olefin resin and a different resin as described above have been mixed, or a film in which a plurality of layers is layered. For example, in the film shown in FIG. 1, a first layer 11, a second layer 12, and a third layer 13 are layered in this order. The first layer 11 and the third layer 13 are, for example, layers in which a cyclic olefin resin, a petroleum resin (mixed resin), and polyethylene (different resin) have been mixed, and the second layer 12 is, for example, a layer in which polypropylene (different resin) and a petroleum resin have been mixed. In this case, a composition containing the cyclic olefin resin and the petroleum resin is separated from the film by the method described later.

The film of FIG. 1 is an example, and may be a film in which two layers or four or more layers are layered. At least a cyclic olefin resin may be contained in at least one layer, and a different resin may be contained in the other layer. Alternatively, it is acceptable that a cyclic olefin resin and a different resin have been mixed in at least one layer. A mixed resin such as a petroleum resin or an additive has not necessarily been added, but when added, it has been mixed with at least one of the cyclic olefin resin or the different resin.

### <2. Method for Separating Cyclic Olefin Resin>

Next, a method for separating a cyclic olefin resin from a film as described above will be described. The separation method includes the following four steps.
(1) Film cutting step
(2) Film dissolution step (first step)
(3) Filtration step (second step)
(4) Cyclic olefin resin separation step (third step)

Hereinafter, each step will be described in detail.

### <2-1. Film Cutting Step>

First, the film is cut into a predetermined size. As a result, the contact area between the cut film and the solvent described later is increased, and the film is easily dissolved. The cut size of the film is not particularly limited, but for example, the film can be cut into a size of 0.1 to 4 cm square, preferably 0.2 to 2 cm square. However, this step is not necessarily required, and in the next step, the film may be immersed in the solvent as it is without being cut.

### <2-2. Film Dissolution Step>

The film cut as described above is then dissolved in a solvent to form a solution. The solvent used here is a solvent in which the cyclic olefin resin can be dissolved and the different resin is not dissolved, but may be, for example, a solvent in which the different resin is slightly dissolved as long as the transparency of the cyclic olefin resin to be recovered is not affected. The solvent may be a solvent in which the above-described mixed resin or additive can be dissolved.

Such a solvent can be appropriately selected according to the type of the cyclic olefin resin to be separated, and for example, a solvent containing at least one of an aromatic solvent, a cyclic terpene solvent, a cyclic ether solvent, or a cycloaliphatic solvent can be used.

Examples of the aromatic solvent include xylene, toluene, benzene, and mesitylene. These can also dissolve the above-described mixed resin such as a petroleum resin and the above-described additive such as a heat stabilizer.

Examples of the cyclic terpene solvent include limonene and pinene. These can also dissolve the above-described mixed resin such as a petroleum resin and the above-described additive such as a heat stabilizer.

Examples of the cyclic ether solvent include tetrahydrofuran (THF) and 2-methyltetrahydrofuran. These can also dissolve the above-described mixed resin such as a petroleum resin and the above-described additive such as a heat stabilizer.

Examples of the cycloaliphatic solvent include cyclohexane, methylcyclohexane, and ethylcyclohexane. These can also dissolve the above-described mixed resin such as a petroleum resin and the above-described additive such as a heat stabilizer.

The cut film is dissolved in a solvent as described above to form a solution. As described above, the cyclic olefin resin can be dissolved and the different resin is not dissolved in the solvent, so that the different resin component containing the different resin precipitates in the solution.

At this time, the temperature of the solution is not particularly limited, and may be room temperature or a temperature higher than room temperature. The higher the temperature, the shorter the dissolution time, so that the separation operation can be made more efficient. For example, the solution is preferably heated to 25° C. or higher, more preferably 50° C. or higher, still more preferably 70° C. or higher, and particularly preferably 90° C. or higher. However, heating to a temperature lower than the boiling point of each solvent is required.

The dissolution time is not particularly limited since it also depends on the amounts of the solvent and the film, but for example, it can be the time taken until precipitation of the different resin component can be sufficiently observed visually. When the solution is heated as described above, the heating time can be, for example, about 5 to 60 minutes, more preferably about 10 to 30 minutes. In the case of dissolution at room temperature, the time can be, for example, 30 minutes or longer, preferably 60 minutes or longer.

For example, in the tests conducted by the present inventor, it was possible to confirm dissolution of the cyclic olefin resin in the time shown below.

TABLE 1

| | Boiling point | Temperature | Dissolution time |
|---|---|---|---|
| Xylene | 139° C. | 90° C. | 20 min or shorter |
| Toluene | 110° C. | 90° C. | 10 min or shorter |
| Limonene | 176° C. | 90° C. | 30 min or shorter |
| THF | 66° C. | 60° C. | 30 min or shorter |
| Cyclohexane | 80° C. | 60° C. | 30 min or shorter |
| Xylene | 139° C. | Room temperature | 60 min or shorter |
| Toluene | 110° C. | Room temperature | 60 min or shorter |
| Limonene | 176° C. | Room temperature | 60 min or longer |
| THF | 66° C. | Room temperature | 60 min or longer |
| Cyclohexane | 80° C. | Room temperature | 60 min or longer |

In this way, when a predetermined dissolution time elapses, the different resin component containing the different resin precipitates. In the case of being heated, the solution is cooled to room temperature after the dissolution time elapses. As described above, the different resin may be dissolved in a solvent of a certain type, but when the solution is cooled to room temperature, the dissolved different resin is precipitated and can be obtained as a precipitate.

### <2-3. Filtration Step>

Next, the filtration step will be described. In the filtration step, the solution in which the precipitate is formed as described above is filtered through a filter. The filter is not particularly limited as long as the filter can separate a precipitate, but for example, a filter having a pore size of 100 μm or smaller can be used. In addition, it is also possible to adopt reduced pressure filtration (suction filtration) in which filtration is performed while the filtrate is being sucked into a reduced pressure container. This enables the filtration time to be shortened.

In this way, the different resin component and the filtrate in which the cyclic olefin resin is dissolved can be separated. That is, the different resin component can be recovered. The recovered different resin component can be reused as a melt-molded product such as a molded body, a film, or a sheet according to its physical properties and degree of deterioration. In addition, it is possible to obtain a reusable recycled material by performing appropriate processing, for example, mixing additives such as the same or different kind of virgin material and/or heat stabilizer with the recovered different resin components depending on the degree of deterioration.

### <2-4. Cyclic Olefin Resin Separation Step>

Next, the cyclic olefin resin is separated from the filtrate. The separation method is not particularly limited, and various methods can be adopted. For example, the cyclic olefin resin can be separated by evaporating the solvent (first method). At this time, the temperature condition and the time condition depend on the type of solvent, and thus are not particularly limited, but for example, the solvent can be evaporated by heating the filtrate at 50 to 200° C. for 0.5 to 2 hours. In addition, it is also possible to adopt distillation under reduced pressure in which the solvent is evaporated and removed in a lower temperature range in a reduced pressure vessel. This enables the separation time to be shortened.

In addition, a poor solvent that does not dissolve the cyclic olefin resin is added to the filtrate to precipitate the cyclic olefin resin, and then the liquid is filtered to obtain the cyclic olefin resin (second method). Examples of such a poor solvent include an alcohol solvent, a ketone solvent, an ester solvent, and water.

Examples of the alcohol solvent include lower alkyl alcohols having a single hydroxy group, such as methanol, ethanol, propanol, isopropanol, and butanol. Examples of the ketone solvent include acetone and methyl ethyl ketone. Examples of the ester solvent include methyl acetate, ethyl acetate, propyl acetate, and butyl acetate.

In addition, a composition containing the cyclic olefin resin is precipitated by cooling a filtrate, and the cyclic olefin resin can be obtained by filtering this liquid (third method). At this time, since the temperature condition and the time condition depend on the type of solvent, the temperature condition and the time condition are not particularly limited, but for example, the precipitate of the cyclic olefin resin can be formed by cooling the filtrate to −25 to 10° C. and allowing it to stand for 0.5 to 2 hours.

The cyclic olefin resin obtained from the filtrate as described above is naturally dried or heat dried for a predetermined time, for example, about 1 to 3 days. At that time, drying may be performed under reduced pressure conditions in order to shorten the drying time. In this way, the cyclic olefin resin can be separated from the film and recovered. The cyclic olefin resin to be recovered may contain the above-described mixed resin or additive.

### <2-5. Others>

The cyclic olefin resin recovered as described above can be melted and pelletized. Further, if necessary, the pellets can be melted to form a film. Alternatively, the recovered cyclic olefin resin may be melted to form a film directly. Thus, a film containing the cyclic olefin resin can be obtained.

For example, a heat-shrinkable film containing the cyclic olefin resin can be produced. Such a heat-shrinkable film may be a single layer of the cyclic olefin resin or a plurality of layers including resin layers other than the cyclic olefin resin. Examples of the other resin layer include a cyclic olefin resin, a polyethylene resin, a polypropylene resin, and a petroleum resin. Alternatively, a virgin raw material derived from petroleum or a virgin raw material derived from biomass may be used. Also, a recycled raw material may be used. In this case, either chemical recycling or mechanical recycling is acceptable.

The layer formed of the recovered cyclic olefin resin may be a single layer or may be contained in a plurality of layers, but the recovered cyclic olefin resin is preferably contained in an amount of 5% by weight or more of the heat-shrinkable film to be produced. The layer formed of the cyclic olefin resin may contain an anti-blocking agent and an additive. Examples of the additive include a heat stabilizer, an antioxidant, an ultraviolet absorber, a light stabilizer, a lubricant, an antistatic agent, a flame retardant, an antibacterial agent, and a fluorescent brightener. The recovered cyclic olefin resin may be reused as a raw material of an original film before recovery.

Such a heat-shrinkable film can be molded by stretching by sequential biaxial stretching. At this time, the longitudinal stretch ratio is preferably 1× or more, and the transverse stretch ratio is preferably 3× or more. The extrusion temperature is preferably 150° C. or higher and 250° C. or lower, and more preferably 160° C. or higher and 240° C. or lower. As for transverse stretching, a preheating zone, a stretching zone, and a heat fixing zone during molding in a tenter stretching machine can be set at 50° C. or higher and 120° C. or lower.

In addition, 5 to 100 wt %, more preferably 10 to 90 wt %, and still more preferably 20 to 80 wt % of the cyclic olefin resin contained in the heat-shrinkable film can be the recovered cyclic olefin resin. It has been confirmed by the present inventor that a heat-shrinkable film containing the recovered cyclic olefin resin in such a content can obtain physical properties equivalent to those of a heat-shrinkable film using a virgin material as the cyclic olefin resin.

### <3. Features>

According to the method for separating a cyclic olefin resin as described above, the following effects can be obtained.
(1) A cyclic olefin resin can be separated and recovered from a film containing the cyclic olefin resin and another different resin without melting as a prerequisite for separation.
(2) When the solvent is heated, the dissolution time can be shortened, but the dissolution can also be performed without heating the solvent. Thus, the cyclic olefin resin can be separated without heating. In particular, when heating is repeated, the cyclic olefin resin is deteriorated and may be colored (transparency may be reduced), and hence the method of the present embodiment is advantageous in this respect.
(3) Since not only the cyclic olefin resin but also a mixed resin and an additive can be dissolved in a solvent of a certain type, the recovered cyclic olefin resin contains the mixed resin and the additive. Thus, for example, a cyclic olefin resin to which an additive such as a heat stabilizer has been added in advance can be recovered, so that it is not necessary to add such an additive (or mixed resin) again, or the recovered cyclic olefin resin can be reused after adding it in a small amount.
(4) As shown in the examples described later, the heat-shrinkable film using the recovered cyclic olefin resin can exhibit physical property values equivalent to those of a heat-shrinkable film using a virgin material of a cyclic olefin resin. Hence, it is considered that the cyclic olefin resin recovered by the above method exhibits performance equivalent to that of the virgin material.

In the above embodiment, a film is subjected to separation, but for example, a cyclic olefin resin and the like can be separated and recovered by applying the above method to a composite material in which the cyclic olefin resin and the different resin have been mixed, such as pellets other than the film. In particular, when 51 v/v % or more of the volume fraction of the composite material is a cyclic olefin resin component, the cyclic olefin resin and the like can be separated and recovered by applying the above method.

### EXAMPLES

Hereinafter, examples of the present invention will be described in detail. However, the present invention is not limited to these examples.

### <1. Target Film>

First, as shown in Table 2, a cyclic olefin resin-containing film as a target of the recovery method of the present invention was prepared.

TABLE 2

| Layer | Composition (parts by weight) | Layer thickness |
|---|---|---|
| First layer | Cyclic olefin resin (60 parts) + | 5.5 μm |
| | petroleum resin (15 parts) + | |
| | ethylene resin (25 parts) | |
| Second layer | Propylene resin (85 parts) + | 29 μm |
| | petroleum resin (15 parts) | |
| Third layer | Cyclic olefin resin (60 parts) + | 5.5 μm |
| | petroleum resin (15 parts) + | |
| | ethylene resin (25 parts) | |

### <2. Recovery Method>

The film was subjected to the step shown in FIG. 2. First, as a pulverization step, the film was pulverized into a size of about 1 cm². Next, as a dissolution step, 3 g of the pulverized film was added to 120 ml of the (±) limonene solvent, which was heated so as to have a solvent temperature of 90° C., and stirred until the film was completely dissolved in the solvent. After heating and stirring for 30 minutes, the heating was stopped and the mixture was cooled to room temperature while stirring. The solution became cloudy.

Next, as a filtration step, the cloudy solution was filtered through a membrane filter (pore size: 1 μm), and separated into a residue and a filtrate. The residue was dried under reduced pressure to remove the solvent, thereby obtaining a colorless recovered material 1. As a dilution precipitation step, the filtrate was diluted by adding 100 ml of isopropanol while stirring. This gave rise to a colorless precipitate. Next, as a filtration step, the solution containing the precipitate was filtered through a membrane filter (pore size: 1 μm), and separated into a precipitate and a filtrate. Finally, as a drying step, the precipitate was dried under reduced pressure to remove the solvent. A colorless recovered material 2 was obtained.

### <3. Analysis of Recovered Material (DSC Measurement)>

DSC measurement data of the recovered materials 1 and 2, a cyclic olefin resin, a petroleum resin, an ethylene resin, and a propylene resin are shown in Table 3 below. In this measurement, differential scanning calorimetry (DSC) was used, and measurement was performed according to JIS K 7122 (Testing methods for heat of transitions). DSC 2910 [trade name, manufactured by TA Instruments] was used as a measuring apparatus. The measured values described in Table 3 indicate the endothermic peak top temperature measured in the range of 40 to 200° C. at a temperature ramp rate of 10° C./min, or the temperature at the intersection point of the baseline and the tangent drawn at the inflection point.

TABLE 3

| Object | DSC measurement value (° C.) |
|---|---|
| Recovered material 1 | 115.3, 134.5 |
| Recovered material 2 | 75.3 |
| Cyclic olefin resin | 84.0 |
| Petroleum resin | 63.1 |
| Ethylene resin | 112.3 |
| Propylene resin | 156.1 |

The measured values of the recovered material 1 are all observed at 100° C. or higher, and it is considered that these are peaks derived from the melting points of an ethylene resin and a propylene resin. In addition, since no endothermic peak or baseline shift appeared at 100° C. or lower, it is considered that the recovered material 1 does not contain a component of a cyclic olefin resin or petroleum resin having a glass transition temperature of 100° C. or lower.

On the other hand, the endothermic peak of the recovered material 2 is observed at 100° C. or lower, and this is considered to be a peak derived from the glass transition temperature derived from a cyclic olefin resin or a petroleum resin. In addition, since no endothermic peak or baseline shift was observed at 100° C. or higher, it is considered that the recovered material 2 does not contain an ethylene resin or a propylene resin having an endothermic peak at 100° C. or higher.

### <4. Analysis 2 of Recovered Material (FT-IR Measurement)>

FT-IR measurement data of the recovered materials 1 and 2, a cyclic olefin resin, a petroleum resin, an ethylene resin, and a propylene resin are shown in Table 4 below. Table 4 summarizes the presence or absence of characteristic peak values that are not overlapped with others among resin component peaks. This measurement was analyzed by an attenuated total reflection method (ATR method) of an infrared spectrophotometer (FT-IR). FTIR Spectrum 100 [trade name, manufactured by PerkinElmer Co., Ltd.] was used as a measurement apparatus.

TABLE 4

| | FT-IR measurement peak (cm⁻¹) | | | | |
|---|---|---|---|---|---|
| Object | 2952 | 2852 | 1447 | 1376 | 718 |
| Recovered material 1 | ◯ | | | ◯ | ◯ |
| Recovered material 2 | | ◯ | ◯ | | |
| Cyclic olefin resin | | ◯ | | | |
| Petroleum resin | | | ◯ | | |
| Ethylene resin | | | | | ◯ |
| Propylene resin | ◯ | | | ◯ | |

The recovered material 1 is considered to be a mixed component of an ethylene resin and a propylene resin since a peak was observed at 718 cm⁻¹, which is considered to be derived from the ethylene resin, and peaks were observed at 2952 cm⁻¹ and 1376 cm⁻¹, which are considered to be derived from the propylene resin.

The recovered material 2 is considered to be a mixed component of a cyclic olefin resin and a petroleum resin since a peak was observed at 2852 cm⁻¹, which is considered to be derived from the cyclic olefin resin, and a peak was observed at 1447 cm⁻¹, which is considered to be derived from the petroleum resin.

From the results of the above DSC measurement and FT-IR measurement, it can be said that the recovered material 1 is a mixed component of an ethylene resin and a propylene resin, and the recovered material 2 is a mixed component of a cyclic olefin resin and a petroleum resin. It was therefore found that a cyclic olefin resin can be recovered by using the recovery method according to the present invention.

### <5. Production of Heat-Shrinkable Film Using Recovered Cyclic Olefin Resin>

Next, a heat-shrinkable film using the recovered material 2 as a raw material (hereinafter, referred to as a recycled material film) was produced in the following procedure. In order to contrast with this, a heat-shrinkable film using a virgin material (hereinafter, referred to as a virgin material film) was also produced. Each film was a film having a three-layer structure with a total thickness of 50 μm in which a surface layer was layered on both surfaces of a core layer, and the thickness ratio of the surface layer/core layer/surface layer was 1/4/1. The raw materials are as follows.

TABLE 5

| | Virgin material film | Recycled material film |
|---|---|---|
| Core layer | Polypropylene resin (70 wt %) | Polypropylene resin (70 wt %) |
| | Polyethylene resin (10 wt %) | Polyethylene resin (10 wt %) |
| | Petroleum resin (20 wt %) | Petroleum resin (20 wt %) |
| Surface layer | Cyclic olefin resin (80 wt %) | Cyclic olefin resin (40 wt %) |
| | Polyethylene resin (20 wt %) | Polyethylene resin (20 wt %) |
| | AB agent (0.1 wt %) | AB agent (0.1 wt %) |
| | | Recovered material 2 (40 wt %) |
| Recovered material 2 Content | 0 wt % | 13.6 wt % |

These materials were put into an extruder having a barrel temperature of 160 to 250° C., extruded into a sheet having a three-layer structure from a multilayer die of 210° C., and cooled and solidified by a take-up roll of 30° C. Subsequently, the film was stretched at a stretch ratio of 6× in a tenter stretching machine having a preheating zone of 105° C., a stretching zone of 89 to 91° C., and a heat fixing zone of 85° C., and then wound with a winding machine to obtain a heat-shrinkable film in which a direction orthogonal to the main shrinkage direction was Machine Direction (MD) and the main shrinkage direction was Transverse Direction (TD).

The following physical properties of each heat-shrinkable film obtained were measured.

### <Heat Shrinkage Rate>

The obtained heat-shrinkable film was cut into a sample having a size of MD 100 mm×TD 100 mm to obtain a test piece. The obtained test piece was immersed in hot water of 70° C., 80° C., or 90° C. or boiling water (100° C.) for 10 seconds, then the test piece was taken out, immersed in water of 15° C. for 5 seconds, the heat shrinkage rate in the MD direction was determined according to the following formula (1), and the heat shrinkage rate in the TD direction was determined according to the following formula (2). Note that LMD in the following formula (1) is the length in the MD direction of the test piece after heat shrinkage, and LTD in the following formula (2) is the length in the MD direction of the test piece after heat shrinkage. The heat shrinkage rate was measured using two test pieces for each heat-shrinkable film, and the average value thereof was used.

$$Heat shrinkage rate ( \% ) = \{ ( 100 - LMD ) / 100 \} \times 100 \qquad ( 1 )$$

$$Heat shrinkage rate ( \% ) = \{ ( 100 - LTD ) / 100 \} \times 100 \qquad ( 2 )$$

### <Haze>

The haze of the obtained heat-shrinkable film was measured using a haze meter (NDH 5000 manufactured by Nippon Denshoku Industries Co., Ltd.) in accordance with JIS Z 7136. The haze was measured using four test pieces, and the average value thereof was calculated.

### <Glossiness>

The glossiness of the obtained heat-shrinkable film at an incident angle of 45° was measured by a method in accordance with JIS Z 8741 using Model VG-2000 manufactured by Nippon Denshoku Industries Co., Ltd.

### <Impact Strength>

The obtained heat-shrinkable film was cut into a sample having a size of MD 100 mm×TD 100 mm to obtain a test piece. The obtained test piece was measured by a method in accordance with JIS P 8134 using a film impact tester manufactured by Toyo Seiki Seisaku-sho, Ltd. Specifically, the test piece is fixed on a stage. Next, by removing the hook fixing the arm of the film impact tester, the fan-shaped arm rotates about the axis, and the impact head attached to the tip of the arm breaks through the test piece. The impact strength is quantified as the energy required when the impact head breaks through the test piece. The impact strength is measured five times, and an average value is calculated.

### <Compression Strength>

The compressive strength of the obtained heat-shrinkable film was measured by a method in accordance with JIS P 8126. Specifically, the following method was used. The obtained heat-shrinkable film was cut into a strip shape having a length of 152.4 mm and a width of 12.7 mm, and set so as to form a cylindrical shape on a support tool prepared in advance, then the support tool was placed on a stand of a ring crush tester (Model D, manufactured by Toyo Seiki Seisaku-sho, Ltd.), and measurement was performed. The measurement was performed on the compressive strength only in the longitudinal direction (film flow direction), n=8, and the average value thereof was taken as the value.

### <Young's Modulus>

The obtained heat-shrinkable film was cut into a sample having a size of MD 250 mm×TD 5 mm to obtain a test piece. The obtained test piece was measured by a method in accordance with ASTM D 882 using Strograph VE-1D manufactured by Toyo Seiki Seisaku-sho, Ltd. The Young's modulus was measured using four test pieces, and an average value thereof was calculated.

The results were as follows.

TABLE 6

| | | | | | Virgin | Recycled |
|---|---|---|---|---|---|---|
| | Item | | Conditions | | material film | material film |
| Physical | Heat shrinkage rate | MD/TD | 70° C. | % | 0/6 | 0/7 |
| properties | (10 s) | | 80° C. | % | 4/37 | 5/37 |
| | | | 90° C. | % | 8/54 | 9/55 |
| | | | 100° C. | % | 11/63 | 10/64 |
| | Haze | | | % | 5.4 | 5.6 |
| | Glossiness | | | % | 134 | 138 |
| | Impact strength | | | J | 0.47 | 0.45 |
| | Compression strength | | | N | 8.5 | 8.3 |
| | Young's modulus | MD/TD | | GPa | 1.4/1.8 | 1.3/1.9 |

As seen from the results in Table 6, there was no significant change in physical property values between the virgin material film and the recycled material film, and thus the recycled material film and the virgin material film can be used equally.

### DESCRIPTION OF REFERENCE SIGNS

11: First layer
12: Second layer
13: Third layer

1. A method for recovering a cyclic olefin resin comprising:
dissolving a composite material containing at least the cyclic olefin resin and a different resin different from the cyclic olefin resin in a solvent capable of dissolving the cyclic olefin resin, to form a solution, and precipitating a different resin component containing the different resin;
filtering the solution and removing the different resin component to obtain a filtrate; and
obtaining a composition containing the cyclic olefin resin from the filtrate.

2. The method for recovering a cyclic olefin resin according to claim 1, wherein the composite material is cut into a predetermined size and then dissolved in the solvent.

3. The method for recovering a cyclic olefin resin according to claim 1, further comprising melting and pelletizing the composition to form a recycled material.

4. The method for recovering a cyclic olefin resin according to claim 1, wherein the solvent contains at least one of an aromatic solvent, a cyclic terpene solvent, a cyclic ether solvent, or a cycloaliphatic solvent.

5. The method for recovering a cyclic olefin resin according to claim 1, wherein the different resin is at least one of a propylene resin, an ethylene resin, a polyester resin, or a polyamide resin.

6. The method for recovering a cyclic olefin resin according to claim 1, wherein dissolving the composite material containing at least the cyclic olefin resin and the different resin different from the cyclic olefin resin in the solvent capable of dissolving the cyclic olefin resin, to form the solution, and precipitating the different resin component containing the different resin comprise heating the solution to a temperature of 25° C. or higher.

7. The method for recovering a cyclic olefin resin according to claim 1, wherein the composition containing the cyclic olefin resin is obtained from the filtrate by any one of:
evaporating the solvent from the filtrate;
diluting the filtrate to precipitate the composition containing the cyclic olefin resin; or
cooling the filtrate to precipitate the composition containing the cyclic olefin resin.

8. The method for recovering a cyclic olefin resin according to claim 1, wherein
the composite material is formed of a film, and
the film includes at least a first layer containing the cyclic olefin resin and a second layer containing the different resin.

9. The method for recovering a cyclic olefin resin according to claim 8, wherein at least one of the first layer or the second layer contains at least one of a petroleum resin or an additive.

10. A method for producing a heat-shrinkable film, comprising:
recovering the cyclic olefin resin by the method according to claim 1; and
producing the heat-shrinkable film using the cyclic olefin resin recovered.

11. The method for recovering a cyclic olefin resin according to claim 2, further comprising melting and pelletizing the composition to form a recycled material.

12. The method for recovering a cyclic olefin resin according to claim 2, wherein the solvent contains at least one of an aromatic solvent, a cyclic terpene solvent, a cyclic ether solvent, or a cycloaliphatic solvent.

13. The method for recovering a cyclic olefin resin according to claim 2, wherein the different resin is at least one of a propylene resin, an ethylene resin, a polyester resin, or a polyamide resin.

14. The method for recovering a cyclic olefin resin according to claim 2, wherein dissolving the composite material containing at least the cyclic olefin resin and the different resin different from the cyclic olefin resin in the solvent capable of dissolving the cyclic olefin resin, to form the solution, and precipitating the different resin component containing the different resin comprise heating the solution to a temperature of 25° C. or higher.

15. The method for recovering a cyclic olefin resin according to claim 2, wherein the composition containing the cyclic olefin resin is obtained from the filtrate by any one of:
evaporating the solvent from the filtrate;
diluting the filtrate to precipitate the composition containing the cyclic olefin resin; or
cooling the filtrate to precipitate the composition containing the cyclic olefin resin.

16. The method for recovering a cyclic olefin resin according to claim 2, wherein
the composite material is formed of a film, and
the film includes at least a first layer containing the cyclic olefin resin and a second layer containing the different resin.

17. The method for recovering a cyclic olefin resin according to claim 16, wherein at least one of the first layer or the second layer contains at least one of a petroleum resin or an additive.

18. A method for producing a heat-shrinkable film, comprising:
recovering the cyclic olefin resin by the method according to claim 2; and
producing the heat-shrinkable film using the cyclic olefin resin recovered.
